(19) United States
(12) Patent Application Publication
(10) Pub. No.: US 2007/0219303 A1
(43) Pub. Date: Sep. 20, 2007

(54) Molding material having optimally-adhered resin and reinforcement

(75) Inventors: Alireza (Ali) Mortazavi, Richmond Hill (CA); Giuseppe (Joe) Mariconda, Newmarket (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, CA

(73) Assignee: Husky Injection Molding Systems Ltd.

(21) Appl. No.: 11/375,933

(22) Filed: Mar. 15, 2006

(51) Int. Cl. C08K 3/26; C08K 3/34; C08K 3/40

(52) U.S. Cl. 524/425; 524/494; 524/449; 524/451

(57) ABSTRACT

Disclosed is a molten molding material. The molten molding material has a resin, and also has a reinforcement included with the resin. The reinforcement was subjected to a degree of motion relative to the resin. The degree of motion being sufficient enough so that a mechanical property of the resin including the reinforcement once solidified is within an optimum range.

### TECHNICAL FIELD

The present invention generally relates to, but not specifically to, molding systems and/or molding materials, and the present invention specifically relates to, amongst other things, a molten molding material having optimally-adhered resin and reinforcements, and/or a system for processing the molten molding material, and/or a method of processing the molten molding material.

### BACKGROUND

PCT Patent Application WO 95/11122 A1 (Inventor: Ibar, Jean-Pierre; Published: 1995-04-27) discloses an injection molding apparatus that includes an accumulator whose plunger may be reciprocated during mold filling and packing to exert modifying forces on plastic melt.

PCT Patent Application WO 00/76735 A1 (Inventor: Ibar, Jean-Pierre; Published: 2000-12-21) discloses a method of controlling viscosity of polymeric materials by shear thinning and/or disentanglement by passing melt through cavity formed by ribbed and rotating surfaces.

U.S. Pat. No. 5,605,707 (Inventor: Ibar, Jean-Pierre; Published 1997-02-25) discloses an injection molding apparatus that includes an accumulator whose plunger may be reciprocated during mould filling and packing to exert modifying forces on plastic melt.

U.S. Pat. No. 6,854,968 (Inventor: Zimmet, Rainer et al; Published 2005-02-15) discloses a compounder-type injection molding machine that has a pressure sensor which determines a melt-pressure state at an outlet of the extruder and outputs signal to a control unit to activate a drive mechanism in a reservoir and an injection device.

In-line compounding systems are used in a process for molding articles with a molding material that has a resin including a reinforcement (such as, glass fibers). These systems may have, for example, a twin-screw extruder that is connected to a shooting pot. It is believed that conventional wisdom, associated with the molding art pertaining to in-line compound molding, directs persons of skill in the art to ensure that the fibers that arrive in a mold cavity are of the maximum-possible length (that is, the fibers have been subjected to a minimal amount of fiber attrition—that is, the fibers have not been over cut). A minimal amount of fiber attrition may be achieved by designing the system in a way that minimizes shearing (cutting) of the fibers as they pass through the system. For example, it is preferred to use a passageway (pipes, etc) that have large diameters, etc. It is expected that the fibers may become inadvertently sheared while they travel from the extruder through the system and into the mold cavity. But fiber attrition is to be kept at a minimum level possible. Unfortunately, the molded articles made according to this wisdom may lack sufficient mechanical properties (such as strength) despite long fibers that are present in the solidified molding material, and this outcome leaves much to be desired.

FIG. 1A is a depiction of a graph 1 indicating mechanical properties versus fiber length (source: Composites Applied Science and Manufacturing, J. L. Thomason) of a molding material having a resin and a reinforcement according to the prior art. The vertical axis 2 indicates mechanical property expressed as a percentage (from 0% to 100%). The horizontal axis 3 indicates fiber length expressed in millimeters (mm) for a given fiber diameter. Alternatively, the horizontal axis 3 may be expressed as an aspect ratio (that is: fiber length divided by the fiber diameter). A curve 4 is the stiffness curve. A curve 5 is the tensile strength curve. A curve 6 is the impact strength curve. Generally, the mechanical property improves if the fiber is kept as long as possible. This wisdom motivates persons skilled in the art to design molding systems that minimize fiber attrition as much as possible as the molding material passes through the system and into a mold.

FIG. 1B depicts photographs of a molten molding material 7 in accordance with the prior art. The molten molding material 7 has a resin 8 including a reinforcement 9. The amount of adhesion is too low (if any) between the resin 8 and the reinforcement 9 (depicted as fibers) but the amount of fiber attrition is acceptable (fibers were not over cut). The resin 8 includes polypropylene. The reinforcement 9 includes glass fibers of about 40% by weight. The molten molding material 7 also includes a coupling agent of about 1% by weight (these are typical numbers). The numbers will vary depending on the type of application for the molding material.

FIG. 1C depicts a magnified photograph of the molding material of FIG. 1B. The fibers appear to be ripped out from the resin because there was a lack of adhesion between the fibers and the resin.

The following technical articles describe the current state of the art directed at a describing the relationship between mechanical properties of a molded article that is made from a molding material having a resin and a reinforcement (such as glass fibers):

(i) In 1996, a technical article was published in which the authors were J. L. Thomason and M. A. Vlug, and the technical article is titled: Influence of fibre length and concentration on the properties of glass fibre-reinforced polypropylene: 1. Tensile and flexural modulus;

(ii) In 1996, a technical article was published in which the authors were J. L. Thomason and W. M. Groenewoud, and the article it titled: The influence of fibre length and concentration on the properties of glass fibre reinforced polypropylene: 2. Thermal properties;

(iii) In 1996, a technical article was published in which the authors were J. L. Thomason, M. A. Wug, G. Schipper and H. G. L. T. Krikort, and the article is titled: Influence of fibre length and concentration on the properties of glass fibre-reinforced polypropylene: Part 3. Strength and strain at failure;

(iv) In 1997, a technical article was published, in which the authors were J. L. Thomason and M. A. Vlug, and the article is titled: Influence of fibre length and concentration on the properties of glass fibre-reinforced polypropylene: 4. Impact properties;

(v) In 2002, a technical article was published, in which the author is J. L. Thomason and the technical article is titled: The influence of fibre length and concentration on the properties of glass fibre reinforced polypropylene: 5. Injection moulded long and short fibre PP; and

(vi) In 2004, a technical article was published in which the author is J. L. Thomason and the technical article is titled: The influence of fibre length and concentration on the properties of glass fibre reinforced polypropylene. 6. The properties of injection moulded long fibre PP at high fibre content.

It appears that the problem with the art is that a molded part (molded by the conventional processes) may have low (undesirable) mechanical properties (such as low impact strength). It would be highly desirable to mold articles that have improved mechanical properties, especially improved impact strength.

It is not immediately apparent how the problem may be solved because there appears to be many factors that potentially control mechanical properties, such as: (i) fiber properties; (ii) fiber content; (iii) fiber diameter and length (that is, avoid over chopping of the fibers so that the fiber lengths that reach the mold are as long as possible); (iv) proportion of voids (that is, air voids in the solidified article); (v) resin properties; (vi) fiber orientation; (vii) degree of mixing of fiber with resin matrix; (viii) degree of wetting of fiber with resin matrix; and/or (ix) the chemistry of the adhesion between reinforcement and resin.

### SUMMARY

According to a first aspect, there is disclosed a molten molding material, including a resin, and a reinforcement included with the resin, the reinforcement subjected to a degree of motion relative to the resin, the degree of motion imparted being sufficient enough so that a mechanical property of the resin including the reinforcement once solidified is within an optimum range.

According to a second aspect, there is disclosed a method, including imparting, to reinforcement of a molten molding material having a resin, a degree of motion relative to the resin, the degree of motion imparted being sufficient enough so that a mechanical property of the resin including the reinforcement once solidified is within an optimum range.

According to a third aspect, there is disclosed a system, including a passageway configured to pass a molten molding material having a resin including a reinforcement, and also including a motion-imparting component configured to impart to the reinforcement proximate of the motion-imparting component a degree of motion relative to the resin, the degree of motion imparted being sufficient enough so that a mechanical property of the resin including the reinforcement once solidified is within an optimum range.

According to a fourth aspect, there is disclosed a system, including a motion-imparting component configured to impart to a reinforcement proximate of the motion-imparting component a degree of motion relative to a resin, the reinforcement and the resin included in a molten molding material receivable in a passageway, the degree of motion imparted being sufficient enough so that a mechanical property of the resin including the reinforcement once solidified is within an optimum range.

The technical effect is that a mechanical property of the resin including the reinforcement once solidified is within an optimum range.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIG. 1A is the depiction of the graph indicating mechanical properties versus fiber length of the molding material having the resin and the reinforcement according to the prior art;

FIG. 1B depicts photographs of the molding material in accordance with the prior art;

FIG. 1C depicts a magnified photograph of the molding material of FIG. 1B;

FIG. 2 depicts photographs of a molten molding material according to a first exemplary embodiment;

FIG. 3A is a schematic view of a system used to process the molten molding material of FIG. 2 according to a second exemplary embodiment;

FIG. 3B is a schematic view of a system used to process the molten molding material of FIG. 2 according to a third exemplary embodiment;

FIG. 4 is a graph representing amounts of relative motion imparted between a reinforcement and a resin of the molding material of FIG. 2; and

FIG. 5 is a graph representing a mechanical property of the molding material of FIG. 2, in which the mechanical property is expressed as a function of relative motion imparted between the reinforcement and the resin.

The drawings are not necessarily to scale and are sometimes illustrated by phantom lines, diagrammatic representations and fragmentary views. In certain instances, details that are not necessary for an understanding of the embodiments or that render other details difficult to perceive may have been omitted.

### DETAILED DESCRIPTION OF THE EXEMPLARY EMBODIMENTS

Generally, it is believed that it is known to impart small amount as possible of relative motion between a resin and a reinforcement of a molten molding material so that attrition of the reinforcement is not overly promoted (that is, to avoid over cutting of the reinforcement or fibers); however, the inventor believes that the problem (and the problem is believed to be not known to the public) rests with not having imparted enough relative motion between the reinforcement and the resin in order to promote proper adhesion between the reinforcement and the resin. By imparting more relative motion, an improvement may be realized in mechanical properties of the molding material.

It is also believed that another solution to the problem is accomplished by increasing an amount of the relative motion between the reinforcement and the resin sufficiently enough so that the degree of motion imparted is sufficient enough so that a mechanical property of the resin including the reinforcement once solidified is within an optimum range.

Also another solution to this problem is preferably accomplished by increasing an amount of a relative motion between the reinforcement and the resin sufficiently enough so that promotion of adhesion between the reinforcement and the resin is improved but not too much relative motion is imparted so as to over-promote fiber attrition (that is, over cutting of the fibers, so that fiber attrition is reduced) to the point where too many short fibers may be created which may negatively impact the mechanical property of the molten molding material once it is solidified. The reinforcement may be also called other names, such as a “filler” (filler is within the scope of the meaning of “reinforcement”).

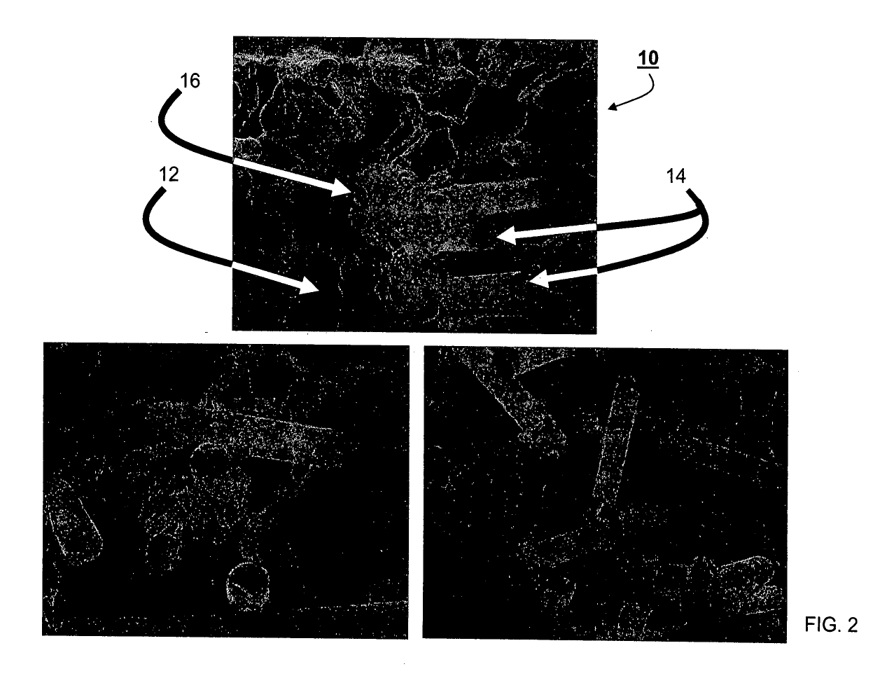

FIG. 2 depicts photographs of a molten molding material 10 (hereafter referred to as the “material 10”) according to the first exemplary embodiment (which is the preferred embodiment). The material 10 has a resin 12 including a reinforcement 14. The reinforcement 14 was subjected to a degree of motion relative to the resin 12. The degree of “relative” motion imparted to the reinforcement 14 was sufficient enough to retard attrition of the reinforcement 14. It is understood that sufficient enough to retard attrition of the reinforcement 14 means that it expected that some of the reinforcement 14 will be cut too short, but not too many that would negatively impact the mechanical quality of the material 10 once it is solidified. The degree of relative motion imparted to the reinforcement 14 was also sufficient enough to promote adhesion between the reinforcement 14 and the resin 12. The technical effect is that a mechanical property of the resin 12 including the reinforcement 14 once solidified is within an optimum range.

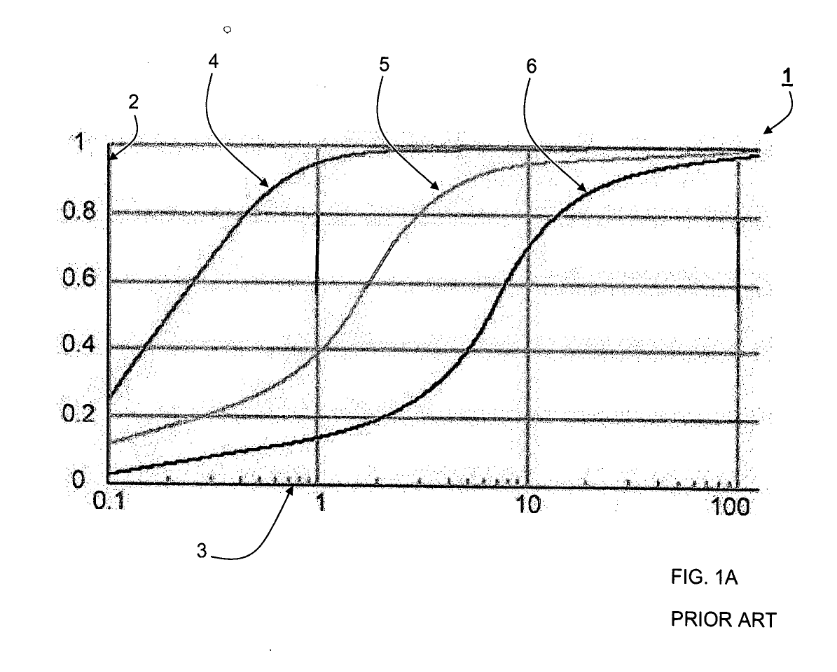

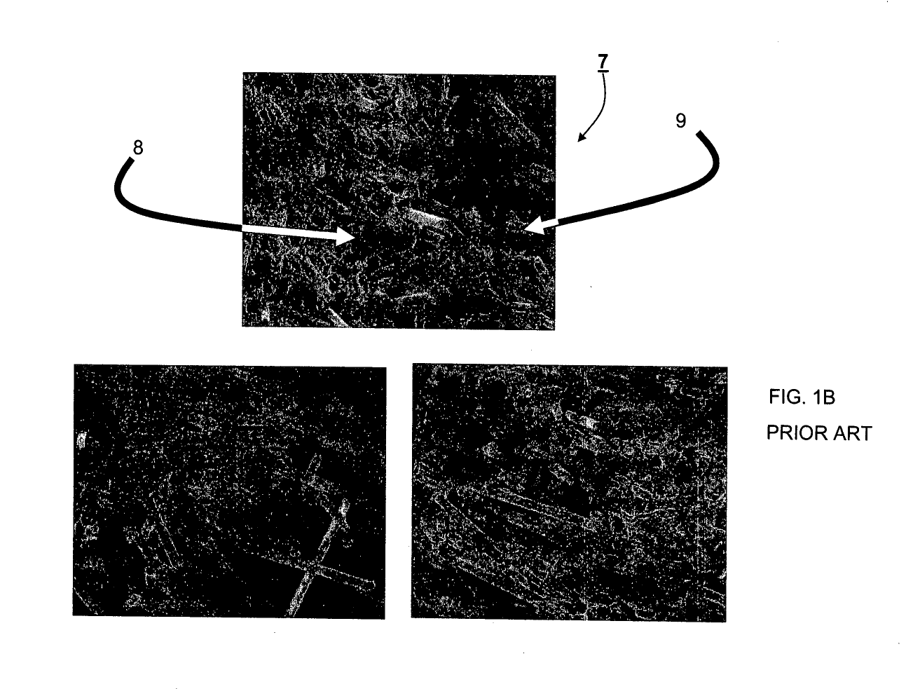

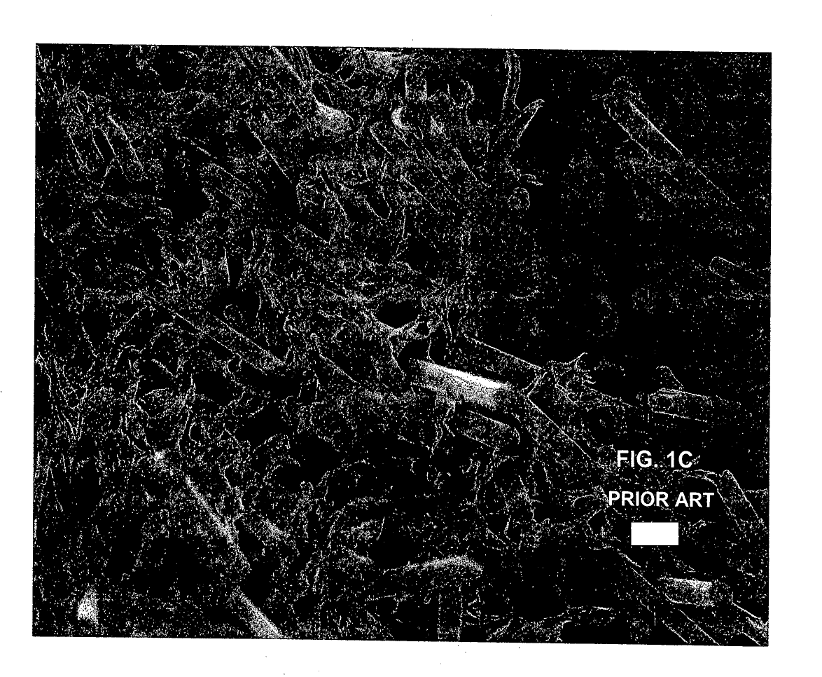

In sharp contrast to the photographs of FIG. 2 in which there is an acceptable degree of adhesion (indicated by arrow 16) between the resin 12 and the reinforcement 14, it is clear from the photographs of FIG. 1B that there is very little (if any) adhesion between the resin 8 and the fibers 9 in the molding material 7. It will be appreciated that the scale of view between FIG. 2 and FIG. 1B appears to be different thereby enhancing the view in FIG. 2. The surface on the fibers of FIG. 1B are clear and show lack of adhesion with the resin at the shown magnification level. A higher magnification level was used in FIG. 2 in order to show the details of the adhesion on the surface of the fibers. It will be appreciated that even if the magnification on the surface of the fibers of FIG. 1B were increased, the surface of the fiber would still appear smooth and clean without significant levels of adhesion with the resin (the fibers appear to be ripped out from the resin as shown in FIG. 1C).

According to a variant, the reinforcement 14 includes a fibrous material, such as glass fibers, carbon fibers, and/or natural fibers, etc. The reinforcement 14 may include any one of glass fibers, carbon fibers, natural fibers (such as wool fibers, wood fibers, etc) and any combination and permutation thereof, which means that the reinforcement 14 could include any single component or a blend of components.

According to another variant, the reinforcement 14 includes a non-fibrous material, such as talc, mica and/or calcium carbonate, etc. The reinforcement 14 may include any one of talc, mica, calcium carbonate and any combination and permutation thereof, which means that the reinforcement 14 could include any single component or a blend of components.

The resin 12 may include a nylon, a polycarbonate, a polyfin, a thermoplastic, etc.

For the sake of simplifying the detailed description, hereafter the reinforcement 14 will be known as the “fibers 14”. It is understood that the description that follows of the “fibers 14” is equally applicable to a non-fibrous material and/or a fibrous material and is equally applicable to any reinforcement used in the resin 12.

Table 1 (below) indicates that by improving adhesion between the fibers 14 and the resin 12, mechanical properties of the material 10 once solidified is improved. The quantity in brackets indicates the amount of improvement (expressed as a percentage over the samples associated with FIG. 1B) that is realized by using the system and method described below.

TABLE 1

| Molding material | | |
|---|---|---|
| having polypropylene | In-flow | Cross-flow |
| and glass fibers (40%) | Direction | Direction |
| Tensile strength [Mpa] | 103 | 63 |
| (increase realized) | (29% increase) | (26% increase) |
| Tensile Modulus [Mpa] | 9400 | 6600 |
| (increase realized) | (29% increase) | (38% increase) |
| Notched Izod [KJ/m2] | 23 | 14 |
| (increase realized) | (53% increase) | (5% increase) |

The numbers in Table 1 will change depending on the type of resin used and the type of reinforcement used in the molding material 10. It is understood that [Mpa] is “megapascals”, and that [KJ/m2] is kilo Joules per meter squared.

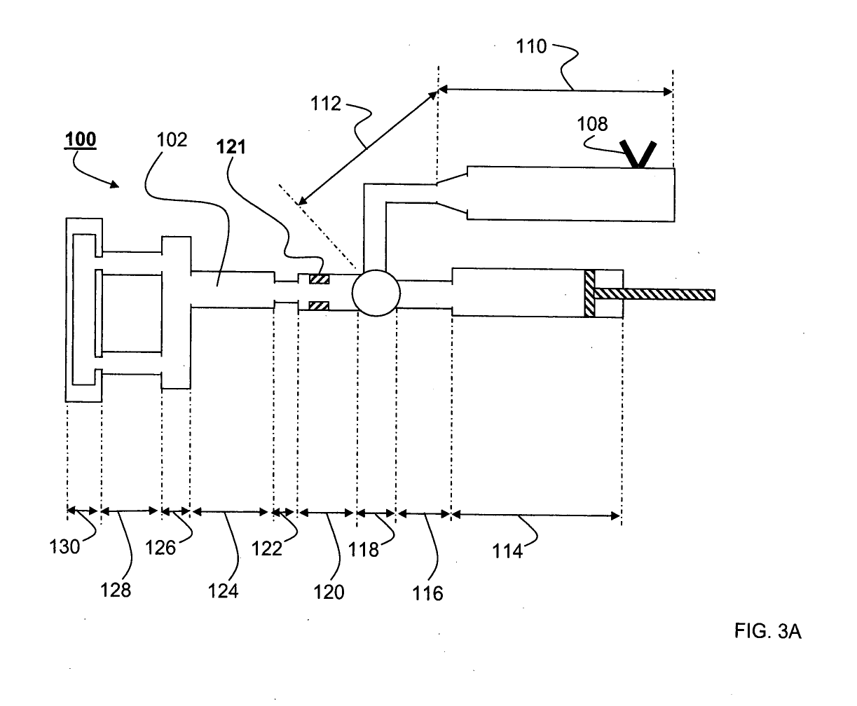

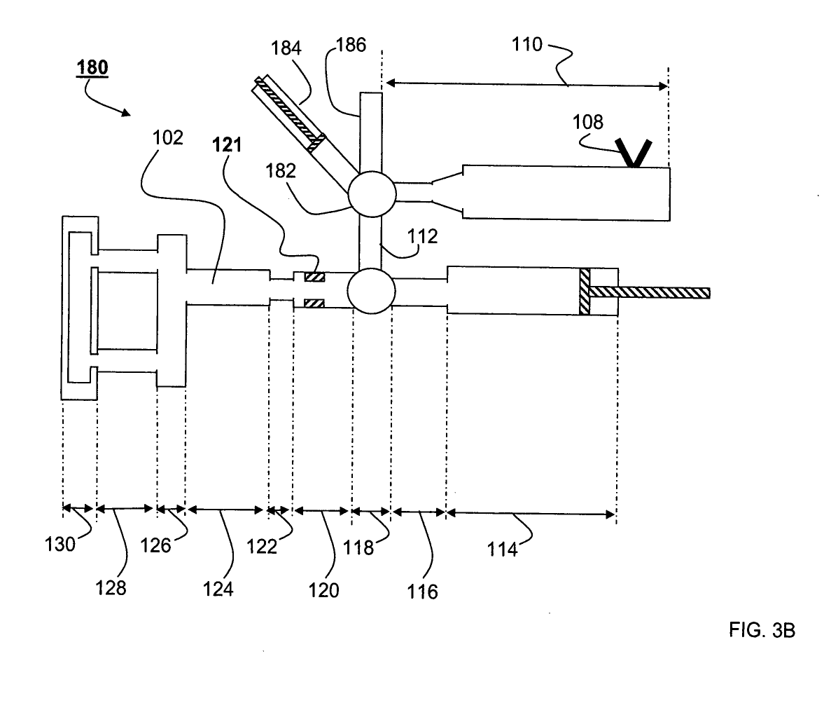

The material 10 was processed by a molding system according to a molding method both of which are described in detail below with reference to FIGS. 3A and 3B.

The degree of motion imparted to the fibers relative to the resin is performed by a motion-imparting component or mechanism, which is described below in detail with reference to FIG. 3A. According to a variant, the motion-imparting component includes a constriction in a passage and the passage is used to pass the resin including the fibers. According to yet another variant, the motion-imparting component includes a source of vibration (such as an ultrasonic-inducing component coupled to the passageway or a mechanical vibrator coupled to the passageway).

Mechanical-testing machines were used to measure different types of mechanical properties of the material 10 once the material 10 was solidified. Standards for mechanical testing are set by governing bodies such as: ASTM standards set by ASTM International (West Conshohocken, Pa., USA), or the International Organization for Standardization (ISO, Geneva, Switzerland). According the first exemplary embodiment, a mechanical property of the solidified material 10 is impact strength.

FIG. 3A is a schematic view of a system 100 that was used to process the molten molding material 10 of FIG. 2 according to the second exemplary embodiment. The system 100 is manufactured by Husky Injection Molding Systems Limited (hereafter referred to as Husky) of Canada. The system 100 is available from Husky and it is known as an in-line compounding system but may be called other names by other manufacturers.

According to the second exemplary embodiment, the system 100 provides a passageway 102 that is configured to pass the material 10 having the resin 12 including the fiber 14. Also, the system 100 preferably includes system components 108, 110, 112, 114, 116, 118, 120, 121, 122, 124, 126, 128 and 130.

The system component 110 is an extruder unit (hereafter referred to as the “extruder unit 110”) that is used to prepare the material 10 into a molten state. According to variants, the extruder unit 110 is a twin-screw extruder unit or a single-screw extruder unit. An input unit 108 is used to feed the fibers 14 into the extruder unit 110 (feed the fibers 14 at the same location as the resin 12 or at a different location). The screws of the extruder unit 110 are also used to chop up the fibers 14 and mix them with the resin 12. Alternatively, one may feed in pre-chopped fibers. The input 108 is included as part of the system 100.

The system component 112 is a transfer unit (hereafter referred to as the “first transfer unit 112”) that is used to transfer the material 10 having the resin 12 including the fibers 14 away from the system component 110 toward the system component 118, which is referred to hereafter as a “distributor unit 118”.

The distributor unit 118 acts as a switching valve to direct the material 10 from the transfer unit 112 to the system component 116. The system component 116 is hereafter referred to as the “second transfer unit 116”. The second transfer unit 116 directs the material 10 to the system component 114 (hereafter referred to as the “shooting pot 114”). The extruder unit 110 keeps processing the material 10 and keeps pumping the material 10 through the transfers 112, 116 and the distributor unit 118 until the shooting pot 114 becomes filled with a desired volume (the shot) of the material 10. Once the desired volume is captured in the shooting pot 114, the extruder unit 110 is no longer required to push the material 10. The distributor unit 118 switches so that the second transfer station 116 is no longer fluidly communicating with the first transfer unit 112 but the transfer station 116 is made to fluidly communicate with the system component 120, which hereafter referred to as the “barrel 120”. Disposed in the barrel 120 is the system component 121, which is hereafter referred to as a motion-imparting component 121.

The motion-imparting component 121 is configured to cooperate with the passage 102. The motion-imparting component 121 is also configured to impart to the fibers 14 a degree of motion relative to the resin 12. The degree of motion imparted by the motion-imparting component 121 is sufficient enough to retard attrition of the fibers 14. Also, the degree of relative motion imparted by the motion-imparting component 121 is sufficient enough to promote adhesion between the fibers and the resin. The result is that a mechanical property of the resin 12 including the fibers 14, once solidified, is within the optimum range. Additional details about the motion-imparting component 121 are provided further below.

The barrel 120 is attached to the system component 122 (hereafter referred to as the “machine nozzle 122”). Once the shooting pot 114 has a sufficient amount of the material 10, the distributor unit 118 switches the shooting pot 114 to the barrel 120, and the shooting pot 114 injects or pushes the shot of the material 10 from the shooting pot 114, through the transfer channel 116, through the distributor unit 118, and into the barrel 120. The nozzle 122 then communicates the shot of the material 110 into the system component 124 (hereafter referred to as the “sprue 124”). The sprue 124 communicates the shot of the material 10 into the system component 126 (hereafter referred to as the “manifold 126”). Then the shot of the material 10 is conveyed into the system component 128 (hereafter referred to as the “manifold nozzles 128”). The shot of the material 10 is then injected into a mold cavity defined by a mold 130. Once inside the mold, the shot of the material 10 solidifies.

According to variants, the system component 121 may be placed in (or cooperate with) any selected system component of the system 100. According to a variant, the motion-imparting component 121 includes a constriction in the passage 102. According to another variant, motion-imparting component 121 includes a source of vibration coupled to the passage 102.

Preferably, the degree of motion imparted to the fibers 14 relative to the resin 12 by the motion-imparting component 121 is a shear strain. The shear strain is proportional to a shear rate imparted to the fibers 14 and a residency time in which the fibers 14 were subjected to the shear rate. Shear rates and residency times will vary according to types of resins and of reinforcements used in the molding material 10 (and also according to the amounts of reinforcement as well).

According to a variant, the shooting pot 114 is configured to implement the function of the motion-imparting component 121, and the motion-imparting component 121 is removed from the system 100. The shooting pot 114 accumulates a shot of the material 10, the shooting pot 114 is then urged to oscillate for a determined period of time so that this oscillation action imparts a relative motion between the fibers 14 and the resin 12. This arrangement is called “melt oscillation” or “melt vibration”. The melt oscillation may occur before the shot is shot out from the shooting pot 114, or during the filling of the mold 130, or during the hold cycle (that is, while a part is being solidified in the mold 130). An ultrasonic-inducing component may also work just as well.

According to a variation, a vibration-inducing component (not depicted) is configured to implement the function of the motion-imparting component 121, and the motion-imparting component 121 is removed from the system 100. The vibration-inducing component is coupled to the system component 112 or other system component that is deemed convenient.

According to a variant, a screw (or screws) of the extruder unit 110 is configured to implement the function of the motion-imparting component 121, and the motion-imparting component 121 is removed from the system 100. The screw is designed to impart the required amount of relative motion between the resin and the fibers.

According to other variants, other mechanisms are used to implement the function of imparting relative motion between the fibers 14 and the resin 12. These mechanisms are mixing activities, restricting the diameter of the passageway 102 (such as an orifice) used by the material 10, inserting a venture in the passageway 102, etc.

FIG. 3B is a schematic view of a system 180 used to process the molten molding material of FIG. 2 according to the third exemplary embodiment. The system 180 is similar to that the system 100 of FIG. 3A, but with the addition of several more system components 182, 184 and 186. The system component 182 (hereafter referred to as the “second distributor unit 182”) is interposed between the component 110 and the component 112. The system component 186 (hereafter referred to as the “second shooting pot 184” or the “buffer” 184) is connected to the second distributor unit 182. The system component 186 (hereafter referred to as the “dump 186”) is also connected to the distributor 182. The buffer 184 is used to collect a shot of molding material from the component 110 while the shooting pot 114 is shooting its shot into the barrel 120. The dump 186 dumps material 10 if required. The buffer 184 may be made to oscillate as well to prepare the shot of the material 10 in the same way that component 121 prepared the molding material 10.

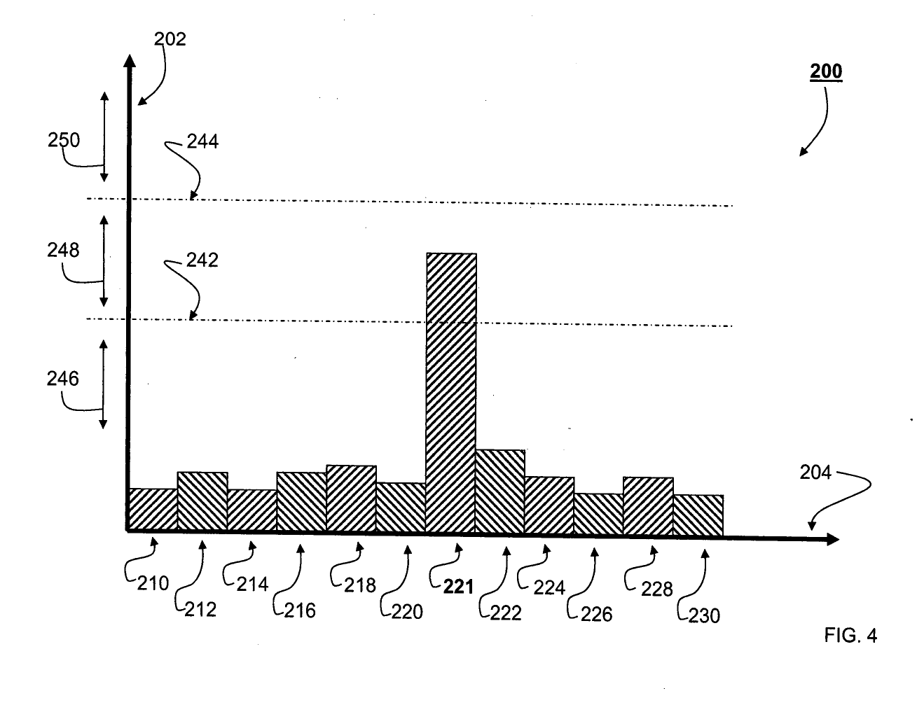

FIG. 4 is a graph 200 representing amounts of relative motion that was imparted between the reinforcement (fibers) 14 and the resin 12 of the molding material 10 of FIG. 2. A vertical axis 202 represents amount of relative motion. A horizontal axis 204 represents a section that corresponds to a system component of the system 100. Section 210, 212, 214, 216, 218, 220, 221, 222, 224, 226, 228, 230 are sections that correspond to the system components 110, 112, 114, 116, 118, 120, 121, 122, 124, 126, 128, 230 respectively. Section 240 corresponds to the system 100.

An optimum range 248 is the optimum or desired mechanical property of the material 10 once the material 10 is solidified. The mechanical property may be derived by testing. Alternatively, the adhesion may be viewed by subjective observation under an electron microscope. It is preferred that only the motion-imparting component 121 imparts the desired amount of relative motion between the fibers 14 and the resin 12 so that the degree of relative motion imparted is sufficient enough to retard attrition of the fibers 14 and it is also sufficient enough to promote adhesion of the fibers 14 with the resin 12, so that a mechanical property of the resin 12 including the fibers 14, once solidified, is optimum.

According to variants, two or more system components of the system 100 are adapted to cooperate and yield the same result as the motion-imparting component 121. This variation may be used with equally good results.

A boundary line 244 represents an upper limit of the optimum range 248, while a boundary line 242 represents a lower range of the optimum range 248.

A below-optimum range 246 indicates that the degree of relative motion imparted between the fibers 14 and the resin 12 are not enough to adversely or negatively increase fiber attrition (that is, not to over cut the fibers 14) but not enough to improve adhesion between the fibers 14 and the resin 12. It is desired for all of the system components to be designed in such as way that as little as possible of relative motion is imparted between the fibers 14 and the resin 12. For example, the average shear and residency time for each system component is such that the resulting imparted relative motion is below the boundary 242. However, at least one system component (such as component 121) must impart enough relative motion between the fibers and the resin that promotes enough fiber-to-resin adhesion without over cutting of the fibers.

An above-optimum range 250 indicates that the degree of relative motion imparted between the fibers 14 and the resin 12 was so much that it adversely or negatively increased fiber attrition (that is, too many fibers 14 were cut too short) but there was good adhesion promoted between the fibers 14 and the resin 12.

Shear Strain of the system 100 is represented by SS in the following equation:
SS=the summation of (shear rate of a component)×(residency time in a component)

Therefore, the shear strain imposed by the system 100 is the summation of the shear rates of each system component multiplied by a corresponding residency time of that component (that is, the amount of time the material 10 is resident in the system component). Preferably, the motion-imparting component 121 is the only component that imparts the required shear strain (that is, the degree of relative motion) that promotes an adequate amount of adhesion between the fibers and the resin, while not adversely affecting fiber attrition (that is, not cutting up too many of the fibers).

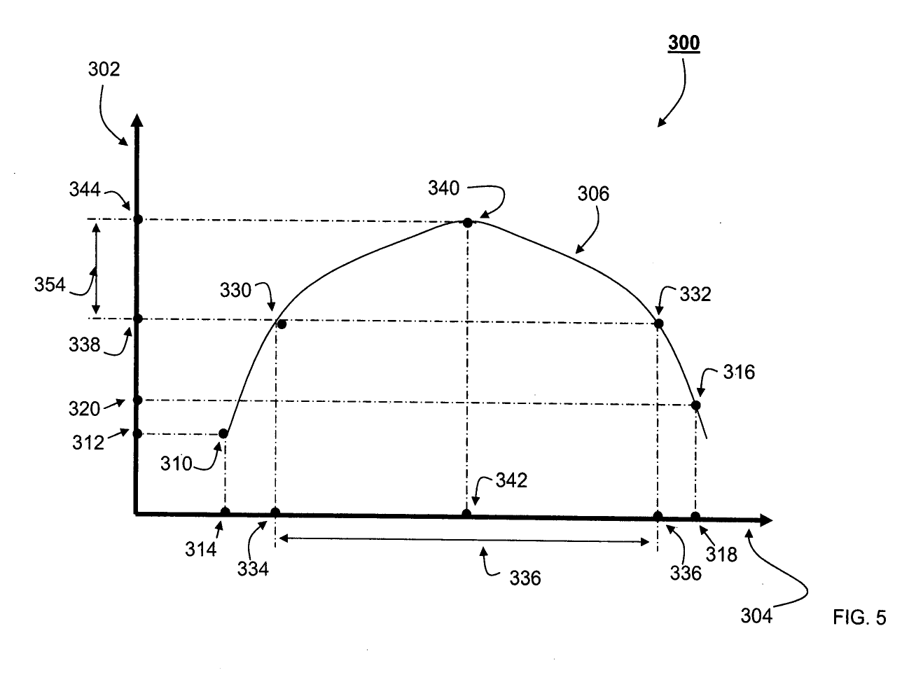

FIG. 5 is a graph 300 representing a mechanical property of the molding material 10 of FIG. 2, in which the mechanical property is expressed as a function of an amount of relative motion imparted between the reinforcement (fibers) 14 and the resin 12 of the molding material 10 of FIG. 2. It is believed that FIG. 5 is not known in the prior art.

Modeling of the shear rate of each component of the system 100 may be generated mathematically by modeling each system component of the system 100 of FIG. 2. This may be accomplished by referring to a textbook titled: “Fluid Mechanics: Injection Molding Handbook” authored by Osswald, Tumg, and Gramann (ISBN: 1-56990-318-2). Reference is made to Section 3.2.2 (simplified flow common in injection molding on page 75, and also to page 77 equation 3.13). While the system 100 may be mathematically modeled, it would be likely difficult to model all possible variables that may influence the mechanical property.

It is preferred to use a measurement-driven approach for determining the graph 300 which would provide an objective indication of the quality of the mechanical property of the material 10 once it has solidified. According to a variant, a subjective observation is used by studying samples of the solidified material 10 by using a microscope for example. The objective measurement approach is preferred over the subjective observational approach.

Examples of types of measurements for measuring mechanical properties are ASTM D638 or ISO 527 for measuring tensile strength (a mechanical property), and ASTM or ISO standard for measuring impact strength (another mechanical property).

According the objective measurement approach, samples of the solidified material 10 were collected for corresponding degrees of relative motion that was imparted to the material 10. To impart differing degrees of relative motion, corresponding modifications were made to the motion-imparting component 121. According to an alternative, differing degrees of relative motion could have been accomplished by adapting various system components. However, it is believed that changing a single system component 121 was the preferred approach so that minimal variations is imposed to the system 100.

The samples of the solidified material 10 were tested using mechanical-testing equipment. The material 10 had the resin 12 that included polypropylene and the fibers 14 that included glass fibers.

Each time a new molding material is to be molded (the material to have a different type of resin and/or a different type of fiber and/or a different amount of resin and/or fiber) by the system 100, new measurements of the mechanical properties associated with that new material would be needed in order to determine an optimum level of relative motion to be imparted between the resin and fibers of that new material so that the molded part made of that new material has the sort of mechanical property or properties that are deemed important or relevant.

The graph 300 includes a vertical axis 302 that is an indication of the quality of a mechanical property of the material 10 once it is solidified. The graph 300 also includes a horizontal axis 304 that is an indication of the degree of relative motion imparted to the material 10. It is preferred that the degree of relative motion imparted between the fibers 14 and the resin 12 is imparted by the component 121 as a shear strain.
Shear strain=SR×T, where; SR=shear rate and T=residency time.

However, other mechanical attributes or conditions may be used to represent the relative motion between the fibers 14 and the resin 12, and that “shear strain” is used out of convenience.

The quality or acceptability of a mechanical property (preferably impact strength or other such as stiffness or tensile strength) of the material 10, once it is solidified, is determined by measurement.

For each measured mechanical property that corresponds to a predetermined degree of shear strain, a collection of points may be plotted onto the graph 300. Once enough points are plotted, the points are fitted with a curve that best fits the plotted points. The curve fitting may be done by eye or may be done using curve-fitting software. Then a best-fit curve is draw through the measured points, and this is represented by the curve 306.

Point 310 represents a shear strain 314 imparted to the fibers in which the system component 121 was removed from the system 100, and this arrangement resulted in a low-quality mechanical property 312 (as measured objectively).

Point 316 represents a shear strain 318 (which is much higher than the shear strain 314) that was imparted by the system component 121 that resulted in another low-quality mechanical property 320 (as measured objectively) because in this iteration, the component 121 was configured to induce way too much relative motion between the fibers and the resin.

Point 340 represents a shear strain 342 imparted by the system component 121 (that was adjusted) that resulted in an optimum-quality mechanical property 344 (as measured objectively). The shear strain 342 is somewhere between shear strain 318 and 314.

Once enough shear strain “sampling points” have been attempted (based on modifications made to component 121 to impart differing relative movements between the fibers and the resin) and their corresponding mechanical property measured, then the optimum point may be identified from the curve 306. The optimum point is the maxima point. The maxima point, in mathematics and particularly in calculus, is a point on the graph of a function where the tangent to the graph is parallel to the x-axis or, equivalently, where the derivative of the function equals zero (known as a critical number). This approach is one of trial and error to locate the optimum point, but nevertheless it is not an approach requiring undue experimentation.

The optimum mechanical property is a point on a graph of a mechanical property as a function of relative motion between fibers and resin of a molding material, where the tangent to the graph is parallel to the relative-motion axis or, equivalently, where the derivative of the function equals zero.

It is a matter of now determining the amount of mechanical property that is acceptable and not acceptable. For example, points 330, 332 represent lower and upper bounds of an optimum range. The lower-acceptable and upper-acceptable shear strain points 334, 336 correspond to the points 330, 332. The lower-acceptable mechanical property point 338 corresponds to the points 330, 332. The upper-acceptable mechanical property point is the point 344. The optimum range of shear strain is indicated by arrow 352 (between the points 334, 336). The optimum range of mechanical property is indicated by the arrow 354 (between the points 344, 352).

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

1. A molten molding material, comprising:
a resin; and
a reinforcement included with the resin, the reinforcement subjected to a degree of motion relative to the resin, the degree of motion imparted being sufficient enough so that a mechanical property of the resin including the reinforcement once solidified is within an optimum range.

2. A molten molding material, comprising:
a resin; and
a reinforcement included with the resin, the reinforcement subjected to a degree of motion relative to the resin, the degree of motion imparted being sufficient enough so that a mechanical property of the resin including the reinforcement once solidified is within an optimum range,
wherein:
the degree of motion imparted is sufficient enough to retard attrition of the reinforcement, and
the degree of motion imparted is sufficient enough to promote adhesion between the reinforcement and the resin.

3. The molten molding material of claim 1, wherein the reinforcement includes a non-fibrous material.

4. The molten molding material of claim 1, wherein the reinforcement includes any one of talc, mica, calcium carbonate and any combination and permutation thereof.

5. The molten molding material of claim 1, wherein the reinforcement includes a fibrous material.

6. The molten molding material of claim 1, wherein the reinforcement includes any one of glass fibers, carbon fibers, natural fibers and any combination and permutation thereof.

7. The molten molding material of claim 1, wherein the resin includes polypropylene, nylon, polycarbonate, polyfin, thermoplastic and any combination and permutation thereof.

8. The molten-molding material of claim 1, wherein the reinforcement include glass reinforcement.

9. The molten molding material of claim 1, wherein the mechanical property of the resin including the reinforcement, once solidified, is at an optimum.

10. A method, comprising:
imparting, to reinforcement of a molten molding material having a resin, a degree of motion relative to the resin, the degree of motion imparted being sufficient enough so that a mechanical property of the resin including the reinforcement once solidified is within an optimum range.

11. A method, comprising:
imparting, to reinforcement of a molten molding material having a resin, a degree of motion relative to the resin, the degree of motion imparted being sufficient enough so-that a mechanical property of the resin including the reinforcement once solidified is within an optimum range,
imparting the degree of motion being sufficient enough to retard attrition of the reinforcement; and
imparting the degree of motion being sufficient enough to promote adhesion between the reinforcement and the resin.

12. The method of claim 11, further comprising:
using a motion-imparting component to impart the degree of motion.

13. The method of claim 11, further comprising:
using a constriction in a passageway to impart the degree of motion, the passageway for passing the molten molding material.

14. The method of claim 11, further comprising:
using a source of vibration to impart the degree of motion.

15. The method of claim 11, wherein imparting the degree of motion includes imparting a shear strain.

16. method of claim 11, wherein imparting the degree of motion includes imparting a shear strain, wherein the shear strain is proportional to:
a shear rate imparted to the reinforcement, and
a residency time in which the reinforcement were subjected to the shear rate.

17. The method of claim 11, wherein imparting the degree of motion includes imparting a shear rate for a determined period of time.

18. The method of claim 11, wherein imparting the degree of motion includes imparting mixing.

19. The method of claim 11, further comprising:
optimizing attrition of the reinforcement; and
optimizing promotion of adhesion between the reinforcement and the resin.

20. A system, comprising:
a passageway configured to pass a molten molding material having a resin including a reinforcement; and
a motion-imparting component configured to impart to the reinforcement proximate of the motion-imparting component a degree of motion relative to the resin, the degree of motion imparted being sufficient enough so that a mechanical property of the resin including the reinforcement once solidified is within an optimum range.

21. A system, comprising:
a passageway configured to pass a molten molding material having a resin including a reinforcement; and
a motion-imparting component configured to impart to the reinforcement proximate of the motion-imparting component a degree of motion relative to the resin, the degree of motion imparted being sufficient enough so that a mechanical property of the resin including the reinforcement once solidified is within an optimum range,
wherein:
the motion-imparting component is configured to impart the degree of motion being sufficient enough to retard attrition of the reinforcement, and
the motion-imparting component is configured to impart the degree of motion being sufficient enough to promote adhesion between the reinforcement and the resin.

22. The system of claim 21, wherein the motion-imparting component includes a constriction in the passageway.

23. The system of claim 21, wherein the motion-imparting component includes a venturi positioned in the passageway.

24. The system of claim 21, wherein the motion-imparting component includes a source of vibration coupled to the passageway.

25. The system of claim 21, wherein the motion-imparting component includes a shooting pot.

26. The system of claim 21, wherein the degree of motion imparted includes a shear strain.

27. The system of claim 21, wherein the degree of motion imparted includes a shear strain, wherein the shear strain is proportional to:
a shear rate imparted to the reinforcement, and
a residency time in which the reinforcement were subjected to the shear rate.

28. The system of claim 21, wherein the relative motion imparted includes imparting a shear rate for a determined period of time.

29. The system of claim 21, wherein the optimum range includes an optimum attrition of the reinforcement and an optimum promotion of adhesion between the reinforcement and the resin.

30. A system, comprising;
a motion-imparting component configured to impart to a reinforcement proximate of the motion-imparting component a degree of motion relative to a resin, the reinforcement and the resin included in a molten molding material receivable in a passageway, the degree of motion imparted being sufficient enough so that a mechanical property of the resin including the reinforcement once solidified is within an optimum range.

31. A system, comprising:
a motion-imparting component configured to impart to a reinforcement proximate of the motion-imparting component a degree of motion relative to a resin, the reinforcement and the resin included in a molten molding material receivable in a passageway, the degree of motion imparted being sufficient enough so that a mechanical property of the resin including the reinforcement once solidified is within an optimum range,
wherein:
the motion-imparting component is configured to impart the degree of motion being sufficient enough to retard attrition of the reinforcement, and
a motion-imparting component configured to impart the degree of motion being sufficient enough to promote adhesion between-the reinforcement and the resin.

32. The system of claim 31, wherein the motion-imparting component includes a constriction in the passageway.

33. The system of claim 31, wherein the motion-imparting component includes a venturi positioned in the passageway.

34. The system of claim 31, wherein the motion-imparting component includes a source of vibration coupled to the passageway.

35. The system of claim 31, wherein the motion-imparting component includes a shooting pot.

36. The system of claim 31, wherein the degree of motion imparted includes a shear strain.

37. The system of claim 31, wherein the degree of motion imparted includes a shear strain, wherein the shear strain is proportional to:
a shear rate imparted to the reinforcement, and
a residency time in which the reinforcement were subjected to the shear rate.

38. The system of claim 31, wherein the relative motion imparted includes imparting a shear rate for a determined period of time.

39. The molten molding material of claim 1, wherein the degree of motion imparted includes a shear strain, wherein the shear strain is proportional to:
a shear rate imparted to the reinforcement, and
a residency time in which the reinforcement were subjected to the shear rate.
